(19) United States
(12) Patent Application Publication
(10) Pub. No.: US 2020/0020203 A1
(43) Pub. Date: Jan. 16, 2020

(54) Method and Apparatus for GPS enabled Live Predictive Sports Game Scoring Outcome Wagering and Social Networking

(71) Applicant: Kent Wilcoxson Jordan, Middletown, RI (US)

(72) Inventor: Kent Wilcoxson Jordan, Middletown, RI (US)

(21) Appl. No.: 16/505,103

(22) Filed: Jul. 8, 2019

Related U.S. Application Data
(60) Provisional application No. 62/695,131, filed on Jul. 8, 2018.

(51) Int. Cl. G07F 17/32

(52) U.S. Cl. CPC G07F 17/3288; G07F 17/3227; G07F 17/3258

(57) ABSTRACT

A method for playing a (live) distributed sports wagering game includes receiving a game prompt for pending live sporting events from a remote terminal, selecting a specific game or match to play, predicting the game score by selecting numerical squares on a game grid, making a cash wager for each square that is selected, submitting the selections to a game server, sending incremental game scores back to each player that has wagered for each period, half or the entire game as the live game progresses, and awarding cash payouts to the players that made correct score predictions for each period, half or the entire game proportionate to the combined cash amount that was wagered and contributed to the betting pool for each game period by all of the participating players. In one embodiment, the sporting event is a football game.

### BACKGROUND OF THE INVENTION

The present invention relates to pre-game and in-game (live) scoring predictions and monetary wagering based on live sporting events. In particular, the present invention relates to pre-game and in-game (live) sports wagering based on a selected sporting event and the actual scoring and/or statistical outcomes within a single period or when the entire game is over. Many sports fans are quite adept at knowing, in general, how an entire team and/or certain individuals may (or should) perform against another team or player.

Many online and mobile sports gaming companies and Las Vegas casinos are now offering multiple ways to wager on sporting events in “Daily Fantasy” or a “European style” of prediction wagering called “In-Game”, “In-Play”, or “Prop Betting”. “Prop” is short for a gambling proposition and props are offered as a pre-set or pre-determined (based on historical statistic or scoring data) wagering opportunity in the daily “betting line” that is published by each individual casino (i.e. “Will team X score over or under 21 points vs team Y today?”). Prop bets are also offered live during the game with what is now commonly called “In-Running” wagering. As one example, Cantor Gaming (CG) offers In-Running wagering at several casinos in Las Vegas using their proprietary mobile devices (a proprietary device similar in design to a small computer tablet).

These mobile devices are designed to be used by a casino patron on the casino premises only (they are temporarily loaned out at the casino sports book when a casino patron opens a cash account), and typically the mobile device must be returned to the sports gaming desk before they check out or leave the casino property.

To make cash wagers with Cantor's In-Running system a patron pays a cash deposit at the casino sports desk to create their own sports wagering account. Their In-Running mobile device provides a screen interface that allows the user to select a pre-set “prop” offering and make a wager (a “prop bet”). Once a particular prop bet is selected the account holder (wagerer) selects and sends the amount they want to wager on the game outcome (usually requiring a minimum amount, perhaps $5). This is done before or during a live sporting event under strict time constraints. Prop bets can be placed on any pro or college sports team that is offered in the system at the casino (football, basketball, baseball, hockey, soccer, tennis, golf, rugby, cricket, volleyball, horseracing, auto racing). The game outcome can be a game score and/or a statistical outcome in a single period, half or the entire game for the offense or defense of either team, or for an individual player on either team, but only on the teams or players that are offered in the system.

With Cantor Gaming's In-Running system a correctly predicted game outcome made by any wagerer awards a cash payout based on the numerical multiplier that is assigned with the pre-set odds while an incorrect prediction subtracts the total amount of the bet from the wagerers account.

As another example Leroy's Sports Book in Nevada (acquired by William Hill) is now offering a very similar “In-Running” mobile service that is also based on an “odds” system, with the odds set by the sports book at Leroy's. This mobile service is offered as a free “downloadable” application (app) for use on any smart phone that is able to run the app (currently available on iPhones, Android phones and Blackberrys) It includes GPS functionality that limits operation to within the state lines of Nevada. This new mobility has set a new precedent in the sports wagering community in Nevada (A valid ID and on site cash deposit at a Leroy's Sport Book location is required. An account cannot be set up remotely). With Cantor Gaming's and Leroy's In-Running game system offerings a wagerer can be very active before or during any single game by making multiple wagers based on the game action as it develops and plays out in the end. The in-game activity offers many additional ways to engage during the game and provides a significant volume of additional wagering. But the drawbacks associated with Cantor's and Leroy's applications are identical. There is a great lack of shared user data and connectivity and a deep need for a live sports wagering system that is directly tied to a proprietary social network. Additionally, Cantor and Leroy's only offer “sports book” style odds based systems. There is no Group—-4-Play available and no pooling of wagers that can shift the focus from playing against “the house” to playing against the other wagerers.

The negative aspects of these two offerings are:
a) The lack of choice as it pertains to the amount that is wagered (i.e. lower end wagers of $1, $2 or $3 are typically not accepted). The minimum amount of money that can be wagered is not as low as an active wagerer might like (as is otherwise available with slot machines). The expectation of Cantor and Leroy's is that the sports wagerer will bet a minimum of $20, $50, $100, or even $1000 on a single bet—providing no opportunities for wagerers to place smaller and more importantly, more frequent bets. Depending on how the wagerer fares with his bets early in the game (and possible losses) their activity could end quickly if things go against him, and he or she may not be inclined to return and play again any time soon.
b) The odds and payouts are limited (often too low), possibly limiting the amount that a wagerer can win and/or causing them to pass on placing the wager altogether due to the lack of “pay off” opportunity.
c) There is no social network. Cantor and Leroy's lack the opportunity to develop a formal relationship (to make a connection and/or place wagerers in any rankings) between all of the individual sports wagerers and/or within any public or private Groups before, during or after the games (i.e. share information—4-regarding about how well (their winning %) or how often they play (low, medium, high activity), which teams/games they want to play with or have already played)
d) All wagers are made directly between the wagerer and the casino (“the house”) and there is no tangible relationship (offered before or during the game (live) or post-mortem) that is shared among the account holders/sports wagerers with respect to sharing and/or competing against each other.

The type of environment offered by Cantor and Leroy's creates a cultural void or vacuum and is predicated on (and is limited to) a two-dimensional relationship between the casino and the wagerer. It lacks the broader knowledge base or culture that can be created, discovered and nurtured through more access and connectivity within the sports wagering community at large.

Today, sports wagerers have to settle for a very limited experience with no sense of how they rank against the other wagerers in any given game, day or season and they do not have the ability to directly play, beat or lose to their counterparts or perhaps even win together by default or as an Organized Team or Group before or after a given event.

Case in point: One of the key factors that attracts consumers to a lottery is knowing how much the jackpot (or pool) is growing to each week and how many lucky numbers (if any) were claimed and paid out the week before. This information is posted online for public viewing every week and offers a basis to participate.

A sports wagering system should be more open, sophisticated and inviting. It should provide the ability to wager in a high volume/low wager system (like the one used for slot machines with $1, $3, $5 or $10 bets), provide access to more information and offer users various ways of communicating. Wagerers should be able to form a public or private group to allow them to bet together (winning or losing as a team).

This type of system and platform will give users more enjoyment by providing:

a) More value (excitement and bigger bang for the buck)

b) A longer and higher volume betting cycle (before and during games, multiple games all day or weekend long)

c) More chances to play and win during a given game (live sporting event)

d) More time of engagement within the system and with other users (before, during and after games)

A need exists for a sports wagering system and service that addresses all of the problems noted above.

Additionally, US. Pat. No. 6,840,861, Jan. 11, 2005, Jordan, et al, is referenced with regards to its Method and Apparatus for Interactive Real-Time Distributed Gaming. This invention contains IP for a subscription based “play for free” live predictive sports game for “Casual Games” that are played purely for entertainment (for points and prizes). It provides the ability make predictions by selecting a statistical and/or scoring “range” outcome that may occur—i.e. 0-50 yds and/or 0-7 pts etc.), but it does not address: a) the need for statistical and/or scoring predictions combined with monetary (cash) wagering, b) a pooling system for the cash wagers, c) weighted cash payouts, d) bonus round qualification, e) a reward points system based on an account holders wagering activities and amounts, f) Global GPS functionality, or g) a proprietary social network for connecting wagerers with others, displaying and sharing pre-game, in-game and post-game wagering information including the cash pool sizes, wagering outcomes (individual and group winning percentages) and account holder cash balances, wagerer rankings and wagerer skill level title assignments.

Further limitations and disadvantages of the historical approaches and the patent that I have cited above will become apparent to one of skill in the art, through comparison of such systems with the present invention as set forth in the remainder of the present application with reference to the drawings.

### BRIEF SUMMARY OF THE INVENTION

A method and apparatus for GPS enabled live predictive sports wagering and social networking. In one embodiment, a method for pre-game and live in-game predictive sports wagering includes receiving at a predictive-game-server system a selected scoring prediction and a specific monetary wager for a given sporting event sent from a web page and/or mobile device, determining the actual game (live sporting event) outcome and the cash payout (if any) for said sporting event, transmitting a game outcome representation to a web page and/or mobile device, and tabulating all of the predictions, monetary (cash) wagers and cash payouts (if any) based on the live sporting event outcomes and a predetermined rule set. In one embodiment, the live sporting event is a football game called “SKWRZ”.

Thus, for example, the pre-game or in-game SKWRZ prediction may be a scoring prediction (i.e., based on a single digit square or the second digit square in the case of a double-digit score) of the final score during a single period, half or an entire game. A pre-set number of prediction options (squares offered as numbers 0-9 for the scoring outcomes, linear or scrambled depending on the selected style) across two separate numerical grids of squares (one for each team) one horizontal and the other vertical, to form 100 total squares. The 100-square grid may be offered at any given time for any given game (live sporting event) via a live game-prompt that is broadcasted and received on a web page and/or mobile device by any account holder that has elected to receive said prompt and/or play live, before or during a specific football game.

Pooling of funds: All monetary (cash) wagers that are made on any single “prediction grid” (i.e. based on a scoring outcome during a single period, a half or the total game), are pooled together to create the cash payout(s) that will be available (if any) to all of the correct predictors (for each individual scoring prediction that was offered) after a single period, half or entire sporting event has ended.

Hypothetical examples of payouts: If 100 people (the total squares offered) bet $10 each for a total pool of $1,000 on a “game score prediction opportunity” (single period, half, entire game), the person or people that selected the correct scoring outcome(s) will receive or split the pool after a “standard gaming fee” has first been deducted. The operator (any third-party operators) will deduct a game fee of perhaps $1 up to $10 or 1-10% depending on what is acceptable and/or allowed within any state and/or federal gaming laws and regulations. (i.e. 5% of $1,000=a $50 service fee).

Formula: After deducting the gaming fee of 5% ($50), the $950 remaining in the original pool of $1,000 is distributed among the correct wagerer(s) (as their share of ownership as a winner(s)).

Example:

It is important to note that even if only a few people make a wager and the full $1000 pool is not filled, a correct prediction(s) can still pay out whatever was wagered in total for that event (i.e. 100 predictions at $10 each totaling $1,000 was offered, but only $720 was wagered on 72 squares before the deadline (what can be called a “partial pool”). 5% of $720=a $36 fee and a payout of $684. Note: A wagerers overall winning %, ranking title and cash outcomes for his or her account are tallied up at the end of each game (live sporting event), game day, game week and season (and will be reflected on the SKWRZ social network). No particular type of computer or web browser should be required, but in the case of a geographically located smart phone application, usage will be limited to the type of phone or PC applications that are made available with GPS or IP address tracking capabilities (i.e. iPhone, Android, Blackberry etc.). The pre-game and in-game predictions are described in much greater detail below with reference to a football game.

### BRIEF DESCRIPTION OF THE DRAWINGS

FIG. 1 illustrates a flow diagram of game-player registration, log-on and game selection.

FIG. 2 shows one implementation of a modular squares game interface console.

FIG. 3 shows a flow diagram for making a square(s) selection

FIG. 4 shows one implementation of a modular social gaming network and game finder interface console.

FIG. 5 shows one implementation of a live game selector interface console

FIG. 6 shows flow diagram for a detect submit button and send squares predictions to a game server

FIG. 7 shows a flow diagram for a live game timing diagram with game sequences for a game system server

FIG. 8 shows a state table describing the game-server, the remote terminal, players and flow of events

FIG. 9 shows a network connection diagram

FIG. 10 shows a flow diagram of a score result received

### DETAILED DESCRIPTION OF THE INVENTION

One implementation of the GPS enabled live predictive sports wagering and social networking system (referred to below generally as “SKWRZ”) is discussed below with reference to a football game (referred to as “SKWRZ Football”) based on a live professional or college football game. Note, however, that SKWRZ is not limited to football games. Rather, SKWRZ may incorporate rule sets for any other competitive sporting activity, including basketball, baseball, hockey, soccer, volleyball, cricket, lacrosse, auto racing and the like.

Prior to each football game, each account holder (sports game wagerer) can select the scheduled game in which he wants to make scoring predictions. The duration of an account holder's ability to make predictions and wagers in that game coincides with the commencement, time periods and duration of the live football game. All prediction prompts sent to the account holders will discontinue at the end of each period or full regulation play for the live sporting event. As will be described in more detail below, each account holder (wagerer) can submit a prediction and a monetary wager before the sporting event expires (before the kickoff for pre-game wagers or before the end of a designated period, the half or the entire game for “in-game wagers”). The account holder (wagerer) will accumulate payouts and/or deductions for playing fees for each correct or incorrect game prediction wager along the way during the game.

As an initial matter, however, an account holder (wagerer) first registers and logs onto the system (“prediction-server-system”) by selecting a scheduled game date/time (i.e. Raiders vs Chargers 11.7.19 1 pm PST) The login server presents login options to the wagerer, including whether to register a new account, or login to an existing account and begin to make squares predictions and monetary (cash) wagers (with money squares). When registering a new account, the registrant enters personal information including, as examples, a promo code and/or username, and it will display several options to opt-in to receive various types of pre-game and/or live game data and additional information about promotions, products and services that may be currently offered or offered in the future.

Subsequently, the prediction-server-system validates the required pertinent information, and if successful, adds the account to the prediction-server-system database. If the prediction-server-system cannot collect the required information, the prediction-server-system returns to where the registrant may correct and resubmit the requested information. An account holder may also opt to cancel their entry to wager and/or receive game data, in which case their account is appropriately marked in the prediction-server-system database.

Once an account is registered in the prediction-server-system database, the account holder (wagerer) may then logon by entering a valid username and password. An invalid username or password may cause the prediction-server-system to display an associated warning, or query the individual trying to logon whether they need to first register. The prediction-server-system preferably allows a wagerer to logon at least 30 minutes prior to initiation of the field-game (e.g., before kickoff) and until the end of regulation play of the live game (sporting event), possibly including overtime.

Once the account holder has logged in, he or she selects a pre-scheduled game date/time that is either going to start soon, or that is already in progress, selecting a game (from one or more lists of pre-scheduled games presented by the prediction-server-system to his account) and he or she is logged on for the duration of that particular game until it ends of he or she logs out.

Next, the prediction-server-system retrieves the account holders current account and winnings (if any) associated with a prior event and/or the selected game and/or team. His account may have a positive balance and his current winnings may be zero, for example, if the wagerer is logging in for the first time, or his/her winnings may be somewhere above zero if the wagerer has played another game before or was playing the current game, but had logged out for a period of time and is returning.

Subsequently, the account holders web page or mobile device loads and executes the SKWRZ client software. For example, the client software may include a proprietary mobile application, web page or a personal computer application. The client software, as described in more detail below, also includes rule sets for tabulating the monetary (cash) winnings that are paid out for a given sporting event (in this case football).

Once the web page and/or mobile device loads the client software, the web page and/or mobile device connects to a selected prediction-system-server that is handling the live-game-session.

The prediction-system-server connection may be synchronous or asynchronous, depending on the web page or mobile device (whether an interactive TV set-top-box in a hotel, a tablet, a web enabled cell phone, a computer with an internet connection, or any other internet connected device, or any device with two-way digital communication capability). The prediction-system-server connection communicates with the account holder (wagerer) as described in more detail below during the game. Note that the account holder (wagerer) may log off the prediction-system-server at any time during the game without jeopardizing any predictions made or accumulated winnings. The account holder may log on again during the same game (i.e., up until the end of regulation play of the game, including overtime). The end of regulation play concludes the SKWRZ Football live-game-session.

The live-game-session starts when the actual on-field game starts. Up to 15 minutes before the opening kickoff, the wagerer may submit a pre-game prediction(s). After the opening kickoff, the live-game-session is considered active throughout the duration of the entire game (live sporting event).

The prediction-system-server further establishes a live-game-session when an account holder (wagerer) has been sent a live game-prompt with prediction options and monetary wagering choices. Before each prompt is sent there may be a waiting period. The waiting period, referred to as the pre-prompt-state, is the period of time between the start of game play and when statistical and/or scoring data (if any) has been generated. While in the pre-prompt-state, the prediction-system-server may accept predictions that have already been generated (i.e. general predictions for overall game performance that are not based on live game play and/or live game data generation).

The prediction-system-server establishes two modes associated with an account holder (wagerer): 1) pre-prompt-mode or 2) post-prompt mode. The attributes of these modes and the transfer from one to another is dependent on the prompts that are sent during the live sporting event and the time allowed before a prediction-prompt has expired (i.e. Prompt 1 is sent, Prompt 1 expires. Prompt 2 is sent, Prompt 2 expires) When a prompt is sent the account holder (wagerer) is in active-prompt-mode. When the prompt expires the wagerer is in passive-prompt-mode. The prediction-system-server and the web page and/or mobile device allow the account holder (wagerer) to submit predictions when the account holder (wagerer) is in the active-prompt-mode (i.e., when the prediction-system-server establishes that a prediction-prompt is still valid).

Preferably, account holders (wagerers) are not allowed to submit any squares predictions and monetary wagers (money squares) during the post-prompt mode; in other words, the prediction-system-server establishes that a particular numbered prompt has expired. Generally, the SKWRZ system determines the start and stop of the active-prompt-mode and therefore alternatively determines the duration of the passive-prompt-mode.

When an active prompt mode expires the account holder (wagerer) is placed in a passive-prompt mode and can no longer make square predictions and money square wagers on an expired prompt (i.e. Prompt 1 was sent during the 1^{st} quarter and subsequently expired in five minutes. When a new prompt (i.e. Prompt 2 for the 2^{nd} quarter) has been published the active-prompt-state starts again until it expires per the assigned time period (i.e. in a few minutes, as did Prompt 1). Thus, the account holder (wagerer) automatically moves between the passive-prompt-state and the active-prompt-state throughout the live game, based on when specifically numbered prompts are sent and later expire in a repeated fashion during the game (live sporting event).

The prediction-system-server may send a message to the web page and/or mobile device to alert the wagerer that the prompt is about to expire (i.e. Prompt 3 will expire in 90 seconds). This gives them ample time to make a square prediction and a money square wager or they can simply pass and let the prompt expire.

The web page and/or mobile device presents a mode change indicator (e.g., a text message, sound, graphic or color change) to the account holder (wagerer). The wagerer may then select and submit a square prediction and a money square wager, or pass and let it expire. In the case of an expiration an expiration notice will be sent to the account holder.

Generally, an account holder (wagerer) will attempt to prognosticate their prediction. In addition to scoring prediction Prompts additional Prompts may be received for offensive or defensive predictions when either team playing is on offense or defense, depending on the in-game opt-ins that an account holder (wagerer) may have selected (i.e. Receive prompts for defense only for team X, receive prompts for offense only for team Y etc.).

Preferably, when the current game mode is the active-prompt-mode, and the account holder (wagerer) is simultaneously in active-prompt-mode, the account holder (wagerer) can submit a selected statistical or scoring prediction and a monetary wager, or simply pass. (the account holder (wagerer) may choose to not make a prediction, without jeopardizing any predictions or winnings already made or accumulated).

The account holder (wagerer) makes the square prediction and money square selections and drags a square (and/or squares) onto the “squares game grid” and clicks a submit button on the web page and/or mobile device (i.e., sending the information to the SKWRZ system) to submit the square prediction and money square wager to the prediction-system-server. The account holder (wagerer) must submit the prediction and wager before the prediction-system changes the active-prompt mode (when it expires) to the passive-prompt mode. In one implementation, a square prediction and square money wager is irrevocable and places the wagerer into a non-submit-mode for that particular prompt number (i.e. the user submits a prediction and wager for Prompt 1 thus not allowing another submission for Prompt 1). In other words, the wagerer cannot place another prediction and wager until the next game-prompt has been sent to them (starting the next active-prompt mode). Note also that if the account holder (wagerer) drags a wager onto a square and fails to submit a wager (i.e. all of the required data) he may be prompted to click “play” to submit the data (and wager). Any predictions that are not submitted by clicking “play” are discarded without being submitted.

A prediction tabulating rule set per each game and game style selected determines how the predictions and wagers are tabulated and the cash is paid out (if any) based on the live game (sporting event) scoring outcomes. A cash payout awarded for a correct prediction is displayed. All Team totals, Offensive and Defensive stats predictions (if any) and scoring combinations are continually tabulated to calculate current winnings.

In one implementation, if an account holder (wagerer) has selected not to continue to wager, he can watch the live sporting event passively. Even though the account holder (wagerer) is in a passive mode the prediction-system-server may award him a cash payout automatically according to a rule set for a pre-game prediction he may have made before the game started. Note, however, that in other implementations of SKWRZ Football, the wagerer may submit defensive scoring (or statistical) predictions according to a predetermined defensive or statistical “game grid” and rule set.

The prediction-system-server automatically updates each wagerer's cash winnings total after each period during the live-game-session (time periods or entire game during a live sporting event). Preferably, cash winnings leaders are displayed on a leader board on the web page and/or mobile device. At the end of the live game event (live sporting event) an account holder's (wagerer's) winnings total is recorded and ranked against all other account holder's (wagerers), for example, by period, game day and/or team or game. The highest-ranking account holder's (i.e. wagerer's) may then be determined according to each game, category and/or winnings total. Furthermore, the prediction-system-server may define numerous winnings totals corresponding to certain rewards. An account holder's (i.e. wagerer's) winnings may be allowed to accrue for more valuable rewards at a future date (bonus game play, coupons etc.). With reference to competition among account holders (i.e. wagerers), all account holders (wagerers) on all networks and platforms may be competing against each other to gain the most winnings and/or rewards points. Group specific play will also be supported. Individual account holders (wagerers) can team up and compete in Groups (public or private) against other Groups of the same number (e.g., up to fifty per side). Individual or Group money winners and/or rewards points leaders may, for example, be divided into casino, day, team, game, city, regional, and national leader board groups. Leader boards are preferably posted after every game period or game, and running season totals may also be posted with a SKWRZ MVP and SKWRZ All-Star teams for each team, division or conference (i.e. Pac12, SEC, NFC and AFC) and MVPs All-Stars for each game or football team. Grand prizes (e.g., vacations, season tickets, sporting goods etc) may be awarded at the end of the season to the account holder (wagerer) with the highest winnings totals, and smaller prizes (e.g., T-shirts, magazine subscriptions, and the like) may be awarded, for example, to the top 100 finishers overall.

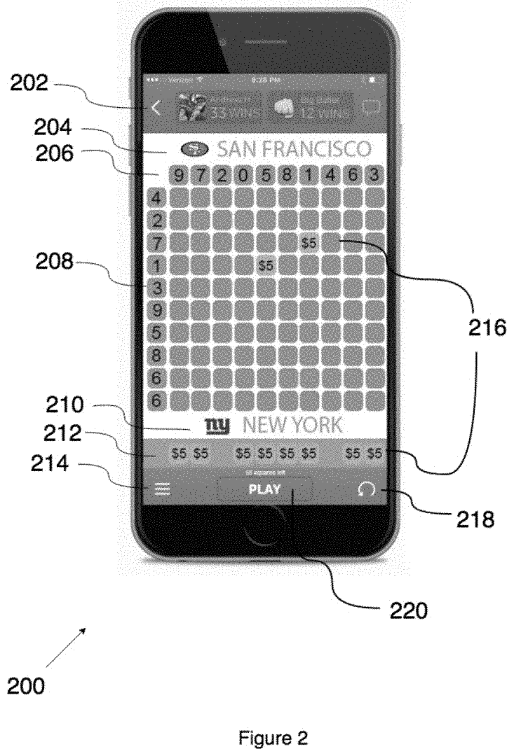

When an Alert and Prediction Prompt are received, it includes scoring (or statistical) choices for the live game outcomes. A wagerer then uses the SKWRZ console 200 (prediction squares and numerical game grid) and drags one or more pre-set denominational squares (i.e. $5 in a “$5 per square” game) in the selector module squares tray 212 in FIG. 2, onto the numerical grid in module 216, to place a money square wager on red 4 and blue 7. The selector module 200 allows the wagerer to select one numbered square at a time by moving squares from the tray in module 212, representing a scoring prediction (single or double digit scores for each team ending in 0, 1, 2, 3 on up to 9 etc.) and a pre-set wager at the same time (i.e. placing a $5 money square), and thereby submit the combined numerical prediction and cash wager to the prediction-system-server by clicking “play”.

In order for the prediction-system-server to award the wagerer a cash payout for a winning prediction, the wagerer must select and submit a square prediction and money square wager in advance of the active-prompt's expiration, as explained above. Then, the score that occurs during the subsequent period (or entire game) must be the score selected by the wagerer (e.g. a total score and/or score during a specific period). Thus, an account holder (wagerer) who submitted a prediction that is correct would be awarded a cash payout according to the pooling rule set given above (i.e., their share of the winnings in the pool that is wagered for that particular prompt/question). Bonus round prompts (offered in the 4^{th} qtr and/or Overtime) are designated with a “Bonus Round” label and selection. The cash payouts for Bonus round predictions may be equal or greater to the payouts offered for the Alerts (Prompts) and Prediction Questions in the early periods (Quarters 1-3 for football and basketball; Periods 1-2 for hockey, the entire first half and first half of the second half clock in soccer and college basketball, the first six innings in baseball etc.). As noted above, however, the account holder (wagerer) will forfeit their money square wager(s) after submitting a scoring prediction(s) that is incorrect (does not occur) after the designated period expires or the entire game has expired. With reference to a Game Outcome (providing the official results after the designated period or the entire game expires), a message (with a label of “correct”, “incorrect” etc.) will represent the status of every Game Outcome for each prediction that is made during any give game (live sporting event).

The SKWRZ prediction game modules in FIG. 2 display the teams, squares, numbers and money square tools. Note that each square prediction and wager is not only submitted to the prediction-system-server, but they are also stored locally in the web page and/or mobile device.

The prediction-system-server may then transmit an actual game outcome representation (quarter by quarter scoring data from the live sporting event) to the web page and/or mobile device. Once the data is received by the web page and/or mobile device it can locally tabulate the cash payout (if any). The prediction-system-server, however, also tabulates the square predictions, money square wagers and game outcome and stores the results in an official database.

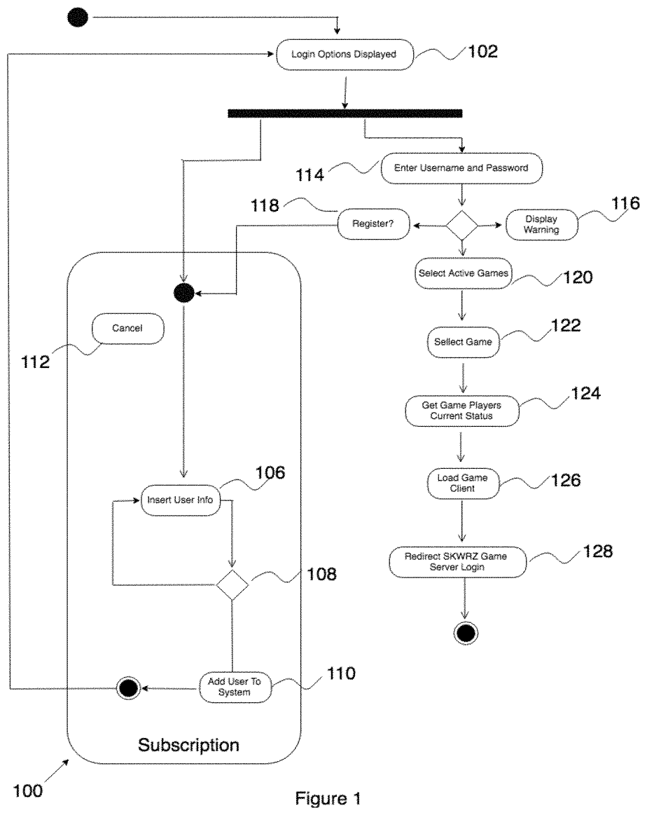

FIG. 1 illustrates a flow diagram 100 for a login display 102, inserting user/pass 106, adding a user 108-110, cancelling 112, entering user/pass information 114, registering to create an account 116-118, select active games 120, select game 122, get status 124, load game client 126 and redirect to game server 128.

Thus, the SKWRZ Football console 200 in FIG. 2 provides, in real time (i.e., as the game events and game periods happen), the interaction between the account holder (wagerer) and the prediction-system-server based on the underlying football game. A link system, tab system and/or or scrolling functionality may be used to view these modules. Preferably, however, the money square selector tray module 212 containing the available money squares, the “play” your wager module 220, modules 204, 206, 208 and 210 will be retained on the interface as the base game interface. Note also that additional modules may be added to the console 200 to extend its functionality. Note also that the console 200 includes an auxiliary display 202 that the console 200 may use to display other wagerers by user name and transmitted auxiliary information including text, graphics, video, and audio based advertising, SKWRZ system informational messages, recaps of the last prediction (if any), or any other type of information. Module 204 displays Team A's logo and city name and module 210 displays Team B's logo and city name. Module 206 displays ten red squares for Team A (San Francisco), one square for each possible scoring number in the field game (0-9), represented as a single digit or the second digit, depending on the actual game score outcomes per quarter, per half and at the end of the field game. Correspondingly, module 208 displays ten blue squares for Team B (New York), with one square for each possible scoring number in the field game (0-9), represented as a single digit or the second digit, depending on the actual game score outcomes per quarter, per half and at the end of the field game. These numbers can be displayed in a linear fashion or jumbled depending on the game style selected by the wagerer. Module 218 functions as refresh button if a wagerer decides to place a money square back into the square selector tray module 212 before selecting play. After a wagerer selects “PLAY” in module 220 the wager is final.

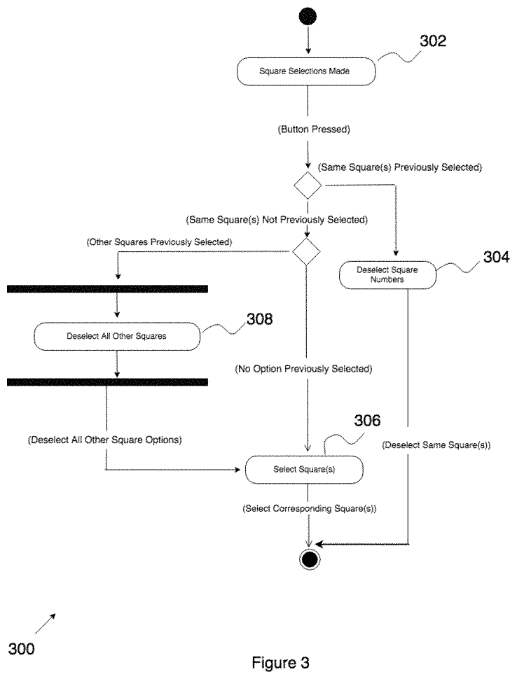

With reference next to FIG. 3, that figure illustrates a flow diagram 300 of a flow diagram for selecting money square predictions using the SKWRZ interface console 200. As an initial matter, note that the console 200 resets at the beginning of an active-prompt mode. (i.e., as each active-prompt is sent sequentially). In other words, the account holder (wagerer) does not need to manually reset the UI to commence new game play on the web page and/or mobile device prior to placing another prediction and wager. Preferably, the console 200 displays and activates the blank prediction squares (static) and money square selector tray module 212 with individual monetary squares (i.e. drag and drop functionality moving each $5 monetary square) only when SKWRZ is in an active-prompt mode and the prediction-system-server is in a submit-prediction-mode.

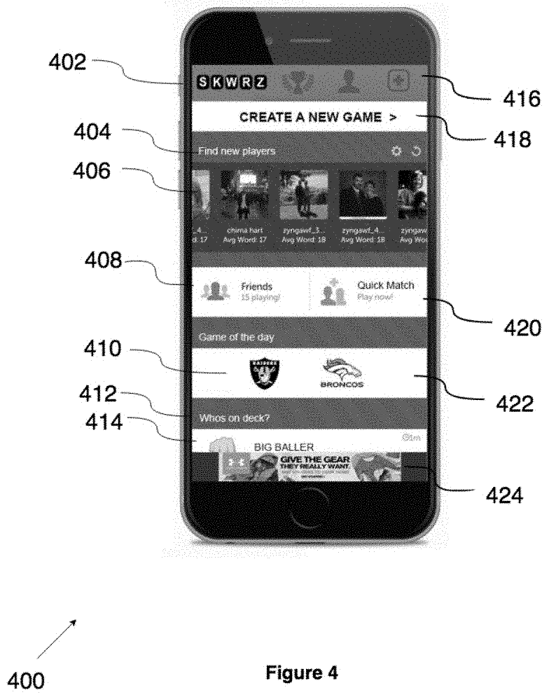

Thus, the SKWRZ Football console 400 in FIG. 4 provides branding 402, a find players feature 404, player thumbnails 406, friend finder 408, game of the day display with team A logo 410, friends on deck and ready to play 414, add a friend button 416, quick match button to play public users 420, game of the day display with team B logo 422 and an ad display 424.

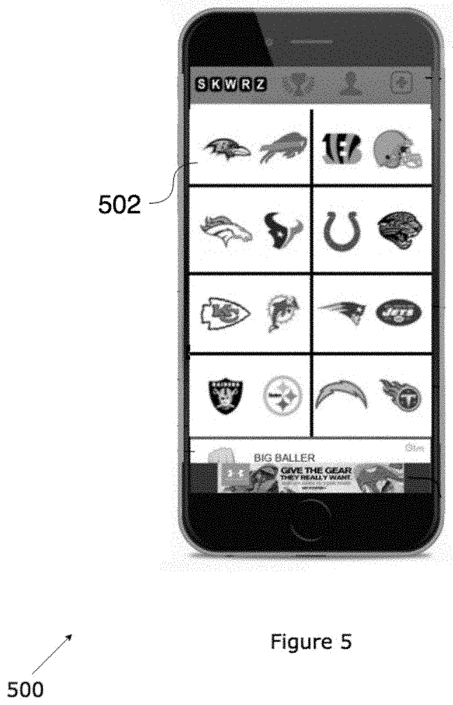

Console 500 in FIG. 5 provides a game selector interface for choosing a SKWRZ game 502 to play in.

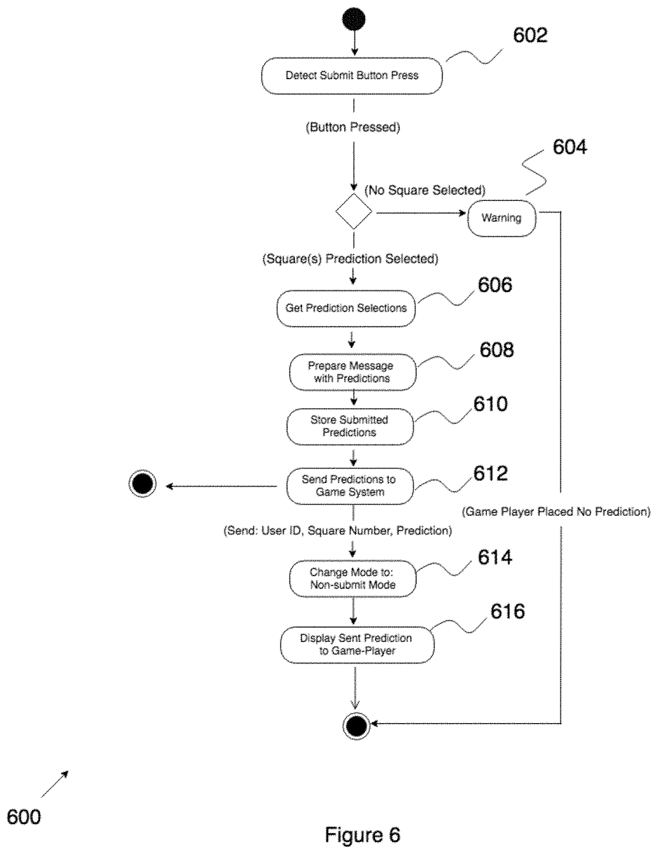

FIG. 6 illustrates a flow diagram 600 for submitting a money square prediction and wager(s) to a prediction-system-server. At step 602, the console 200 detects that the account holder (wagerer) has submitted a money square 216 from the money square tray 212. If the wagerer did not select a prediction and wager using the squares board on console 200 and money square 216, then the console 200 issues a warning 604 (e.g., a sound, graphic, color change or text display) to the wagerer. If however, a prediction square 216 and money square wager has been selected using the money squares in 212, then the console 200 retrieves the prediction and wager(s) 606 and prepares a message 608 containing the prediction(s) and wager(s) for the prediction-system-server. In addition, the console 200 stores the prediction locally 610. Next, at step 612, the console 200 sends the prediction and wager information (e.g., wagerer identification, prompt number, prediction number(s) and the like) to the prediction-system-server. Once the console 200 has sent the prediction(s) and wager(s), the console 200 changes modes to a non-submit-mode 614. In other words, preferably, the wagerer can only submit a single set of squares predictions and money square wagers for any given active-prompt mode state. At step 616, the console 200 updates (resets) the prediction selection module 216 in accordance with the submission of a square prediction(s) and money square wager(s).

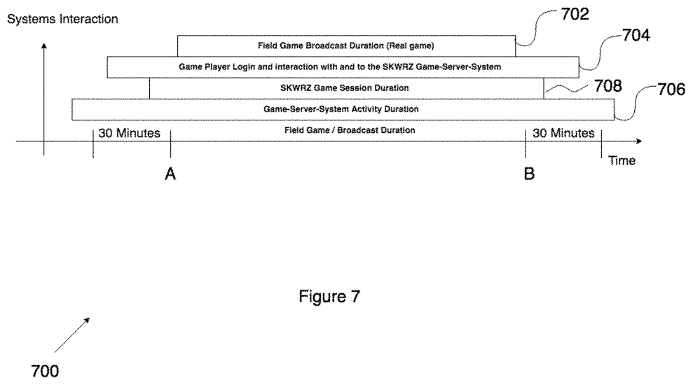

With reference to FIG. 7, a timing diagram 700 provides a high-level summary of operation of SKWRZ Football. In particular, the live game (live sporting event) time 702 starts (e.g., with the kickoff) at point A and ends (e.g., with the final whistle) at point B. Preferably, up to 24 hours before the game starts and until the field-game ends, a wagerer may interact 704 with the SKWRZ Football prediction-system-server (e.g., by logging in and submitting square predictions and money square wagers). The prediction-system-server activity 706 occurs before period 704, however, in order to prepare, for example, for squares wagerers logging in. In addition, the actual SKWRZ Football live-session 708 extends from a few minutes before the live game (live sporting event) starts until a few minutes after the game (live sporting event) ends. SKWRZ users may preview player rankings, game fees, cash payout totals, and the like on their mobile app or at the SKWRZ web site any time between any games (before, during or after live sporting events).

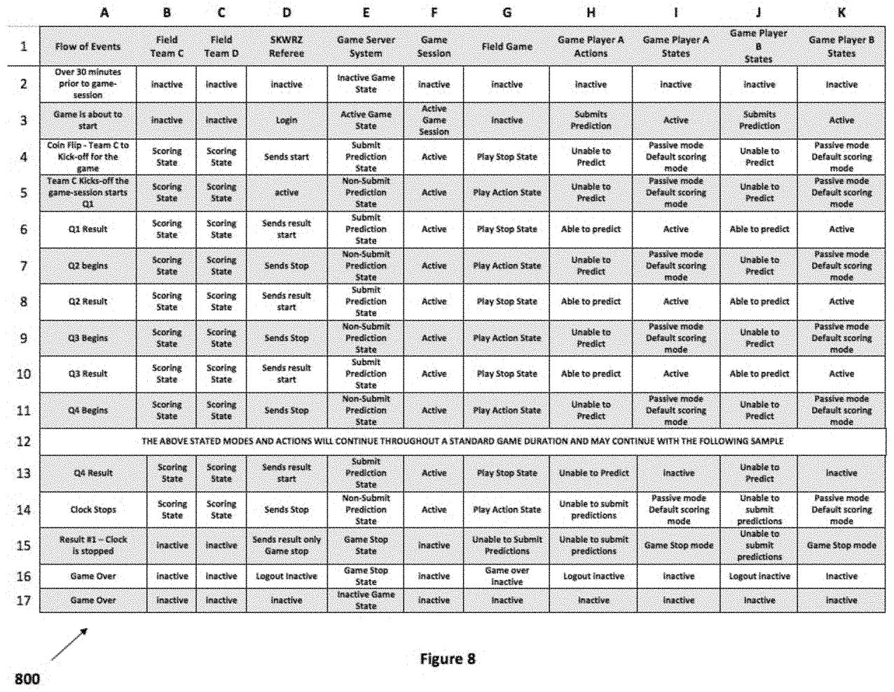

Turning next to FIG. 8, that figure illustrates a state table 800 with columns labeled A-K and rows labeled 1-17. The state table 800 provides one embodiment of the way in which the SKWRZ Football “states” change before, during, and after a live game (live sporting event). Thus, in row 2, representing more than 30 minutes before the live game (live sporting event) starts, all squares wagerers, squares teams or squares groups, and the actual sports teams are inactive. In row 3, representing any time before the game (live sporting event), the wagerers can login. Next, in row 5, it is assumed that the kickoff takes place. Thus, SKWRZ (cell F:4) is now active. The SKWRZ prediction-system-server sends a message to the web page and/or mobile device with a Start signal (cell D:4).

Thus, the prediction-system-server is now in a submit prediction state mode (cell E:4), while the prediction-system-server is in a passive default-scoring-mode to tabulate any pre-game predictions and wagers that have been submitted by any players (cell H:6 and J:6).

When the live game (live sporting event) begins, the SKWRZ prediction-system-server is in a Non-Submit Prediction State and sends a Stop signal to the web page and/or mobile device that the pre-game predictions are no longer accepted (cell E:5). In other words, play has commenced, and pre-game predictions (or pre-period predictions) may no longer be submitted for the current live game (live sporting event).

The flow-of-events continues in similar fashion from cells B:5 and C:5 through cells B:11 and C:11 where the state table 800 assumes that the current live game (live sporting event) has begun and will proceed through the last opportunity to predict and make a wager row 10. Thus, the current game (live sporting event) in row 4 enters the submit-prediction-state (cell E:4). When the live game (live sporting event) is in pre-prompt-mode in the inactive game state (cell E:2), a wagerer can receive a game-prompt (cell 1:10) and may then submit a prediction and wager. As the flow-of-events proceeds, the SKWRZ account holders (wagerers) that have opted-in for that particular game (live sporting event) enter and leave a) pre-prompt-mode, b) active-prompt-mode and c) post-prompt-mode with coordination by the SKWRZ prediction-system-server (that also transmits the results of each prediction and wager to the web page and/or mobile device for local scoring purposes). After the game (live sporting event), all account holders (wagerers) enter game-stop-modes in which no predictions and wagers are allowed (cells I:15 and K:15), the live game (live sporting event) becomes inactive (cells B:15 and C:15), and the prediction-system-server enters a game stop state (cell E:15). The account holders (wagerers) logout (cells H:16 and J:16) (with the prediction-system-server entering an inactive game state) (cell E:17), for example, 10 minutes after the end of the game.

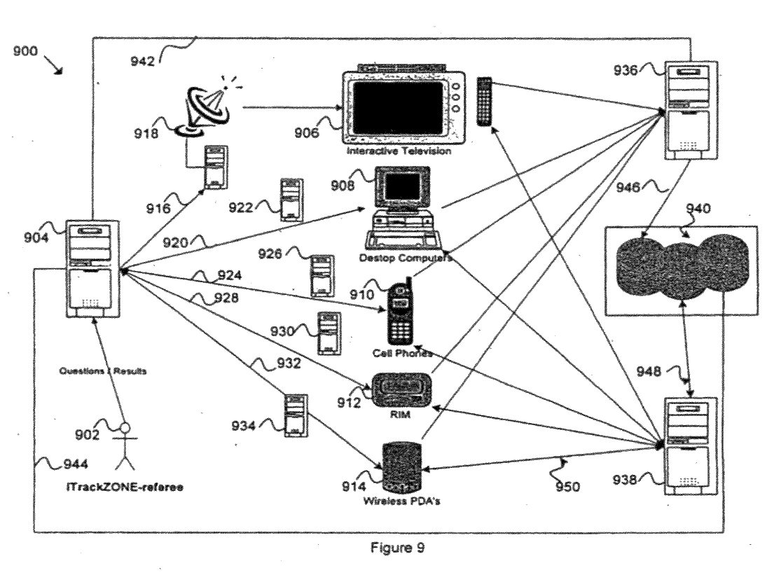

Turning next to FIG. 9, this figure illustrates a connection diagram of a SKWRZ network 900. In order to facilitate explanation, the network 900 is described with regard to the information flow around the network 900, beginning with the SKWRZ player 902 and prediction-system-server 904. The SKWRZ prediction-system-server 904 inputs live game (live sporting event) square prediction and wagering results (e.g., based on actual game scoring, and the like), state-changes (e.g., shown in the state table 800), and any other pertinent information (e.g., cash pay outs, bonuses, rewards points, promotions, and the like) 904.

Subsequently, the prediction-system-server 904 propagates outgoing data to the exemplary web pages and/or mobile devices, including, without limitation, an interactive television 906, a desktop computer 908, a smart phone 910, a pager 912, and a wireless Personal Data Assistant 914. Thus, the prediction-system-server 904 communicates the outgoing data over the network link 916 to the television transmitter system 918. As an example, the prediction-system-server 904 may communicate an outcome representation (i.e., a data representation of the outcome of a period and/or game that may be decoded and processed by the web pages and/or mobile devices 906-914). In turn, the television transmitter system 918 formats the outgoing data for transmission on a preselected television station for reception by the interactive television 906.

Similarly, the prediction-system-server 904 may communicate the outgoing information through the network link 920 (e.g., over the Internet or a local network) through the intermediate gateway 922 to the desktop computer 908. The prediction-system-server 904 may also send the outgoing information through the network link 924 to a cellular base station 926 to the cellular phone 910 and GPS system.

As noted above, when the web pages and/or mobile devices receive an actual prediction and wagering outcome representation, they tabulate the squares predictions and wagers, if any, stored locally in the web pages and/or mobile devices. Furthermore, the web pages and/or mobile devices may also display other received outgoing information, such as auxiliary information or text information including advertising and the like. It is noted that where the web pages and/or mobile devices provide for transmit capability (e.g., as with the desktop computer (908), the web pages and/or mobile devices may also send information back to the SKWRZ prediction-system-server 936.

Continuing with reference to FIG. 9, note also that the prediction-server-system may optionally include an SKWRZ web server 938, SKWRZ database manager 940. In particular, the web server 938 may communicate with the web pages and/or mobile devices 906-914 to handle username and password validation, new account holder (wagerer) registration, general web browsing, ad engagement, merchandise purchasing and the like. The prediction-server-system 936 may comprise a network connected server that receives answers from the web pages and/or mobile devices 906-914. The SKWRZ web server 938, the prediction-system-server 904, and the web pages and/or mobile devices 906-914 may bi-directionally communicate with the SKWRZ database manager 940 over the network links 942, 944, 946, 948, 950, and 951. thus, the SKWRZ database manager 940 may hold a central repository of any account holder (wagerer) information, statistics, merchandise order information, and the like. As one example, the database manager 940 may store account holder (wagerer) cash payout totals and/or rewards points for subsequent retrieval (including by the web pages and/or mobile devices 906-914), rankings, bonuses and/or awards. As another example, the database manager 940 may store each square prediction and wager from each account holder (wagerer). Thus, the prediction-system-server 904 or SKWRZ 902 may communicate actual game outcome representations to the database manager 940 through the prediction-system-server 936. The database manager 940 may then apply rule sets to each account holder's (wagerer's) squares predictions and wagers and obtain an official running tally of each wagerer's cash payouts and/or rewards points totals.

The network links illustrated in FIG. 9 may be implemented as terrestrial wire or wireless links, GPS/satellite links, and combinations of terrestrial wire or wireless links and GPS/satellite links. As a result, the web pages and/or mobile devices 906-914 may be distributed and functional around the world and/or limited in their functionality and or operability based on their specific geographic location.

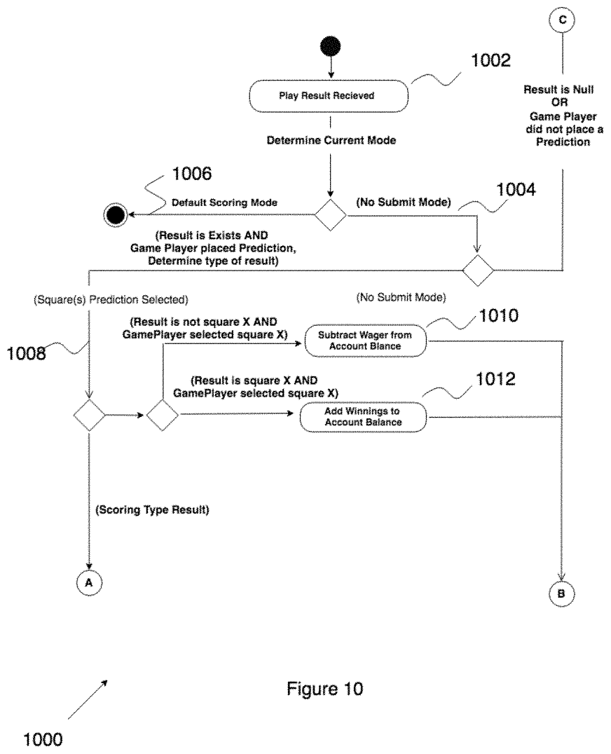

Turning next to FIG. 10, this figure illustrates a flow diagram 1000 of active-prompt mode scoring. Updating the account holder's (wagerer's) cash winnings, rewards points and winning percentage. First, a remote terminal receives an actual game outcome representation 1002 (e.g., from the prediction-system-server 904) for the field-team(s) C and/or D in FIG. 8. If the remote terminal is in the non-submit mode, then the remote terminal proceeds 1004, as noted below, to update the account holder's (wagerer's) score. Otherwise, the remote terminal proceeds 1006 and the Default Scoring Mode.

As an initial matter, note that if the account holder (wagerer) has not placed a prediction and wager or if the result is NULL (i.e., no scoring is applicable to what occurred on the actual playing field), then processing follows branch C. Otherwise the remote terminal determines 1008 the result is a scoring result in branch A.

With reference first to a scoring result, if the squares prediction in the web page and/or mobile device is incorrect the systems subtracts 1010 the amount of the account holder's money square(s) wager. When the squares prediction outcome matches the correct field game scoring number, the account holder is awarded 1012 a cash payout based on their individual money square wager(s) (i.e. the account holder's payout is based on the period (1st quarter, 2nd quarter of halftime, 3rd quarter, 4th quarter or final game score, depending on the game style they are playing). The amount of the wager is subtracted for an incorrect prediction (as shown by branch 1012). Processing then continues at branch B.

Branches A and B converge at the point where the web page and/or mobile device updates the account balance of the account holder. Branches A, B, and C meet at the point where the web page and/or mobile device will display the prediction result. After determining the new account balance for the account holder, the web page and/or mobile device updates the cash balance. Thus, SKWRZ provides a user friendly, easy to understand and play, live social mobiles squares wagering system and platforms. Squares predictions and money square wagers are tabulated locally at each web page and/or mobile device, while being tabulated officially within the prediction-system-server network. The SKWRZ network configuration can further provide each web page and/or mobile device with trivia, merchandising, and other informational and retail services.

### SKWRZ Glossary

Active-game-state: A state describing that the game-system is active in processing predictions and wagers. The prediction-system-server enters the active-game-state, for example, 5-30 minutes prior to the start of the live game (live sporting event)

Active-mode: a mode assigned to a wagerer when the preselected-team is in the offensive-state. The active-mode allows the account holder (wagerer) to take specific actions and makes specific options available to the account holder (wagerer).

Default-scoring-mode: A state that exists when the wagerer's preselected-team is in a defensive-mode. Points are scored by default and attributed to the wagerer when that wagerer's preselected-team scores points in the field-game.

Field-game: refers to the actual physical football game that is ongoing for the duration of a game session.

Field-teams: the teams that are playing football in the live game (live sporting event)

Flow-of-events: The flow-of-events refers to the actions that happen through time after the commencement of the live game (live sporting event). The Flow-of-events will dictate the actions taken (sending prediction prompts, game updates, settling cash awards to account holders etc.) by the prediction-system-server and how a wagerer may interact with the SKWRZ system at any instant in time. The Flow-of-events provides specific game states, prompt modes and accessibility for account holders (wagerers), the play-action results, the start and stop of the live game (live sporting event) clock, and the like, until the end of the live game (live sporting event) and each SKWRZ game session.

Account holder (Wagerer): the person playing SKWRZ using the SKWRZ live game system.

Prediction-system-server: a system comprised of a server or a group of servers that handle the SKWRZ game flow-of-events, Account holder (wagerers) actions, and the like.

Live-Game-session: The live-game-session starts, preferably, 10 minutes before the actual Field-Game starts (the field-game starts at kick-off) and the game-system becomes active. The live-game-session lasts until the end of the Field-Game.

Inactive-game-state: refers to a state of the prediction-system-server during which the prediction-system-server is considered to be inactive, i.e., prior to the commencement of the Active-game-state (e.g., prior to 30 minutes before the scheduled kick-off in the Field-Game and/or after the Field-Game and live-game-session have finished).

SKWRZ Referee System: The live-game-session official(s) (real or automated) for the SKWRZ game. The SKWRZ Referee System will monitor the flow-of-events of the live sporting event to determine the states of the prediction-system-server during the game session. The SKWRZ Referee instructs the game server to transmit the play results of each play to allow processing of the next play predictions, and set the start and stop prediction states that determine the prediction modes for the wagerers.

Non-submit-mode: The non-submit-mode coincides with the duration of the play-action-state of a wagerers preselected field team. The non-submit-mode begins when a wagerer's preselected-team breaks the huddle to approach the ball to commence a play in the field-game, initiating the play-action-state. During the non-submit-mode, a wagerer in active-mode cannot submit next play predictions. A wagerer is also automatically placed in a non-submit-mode when he selects and submits a next play prediction to the game-system. In one embodiment, the next play prediction submission is irrevocably submitted to the game-system and temporarily suspends that wagerer's game session, placing the wagerer into the non-submit mode. Thus, preferably, the wagerer cannot make a different selection and submission until after the ball is blown dead by a field referee and the next submit-prediction-mode begins.

Passive-mode: a mode assigned to a wagerer when the preselected-team is in defensive-state. In passive-mode, the wagerer will not be able to select or submit any predictions until his preselected-team assumes an offensive-state.

Play-action-state: refers to a state of the overall game-system that corresponds with the live action football plays in the Field-Game. The play-action-state begins when the ball is snapped and ends when a Field-Game official blows the whistle to indicate a dead ball. When the game-system is in the Play-action-state a wagerer is not allowed to select and submit predictions.

Play-stopped-state: refers to a state of the game-system that corresponds with the live action football plays in the Field-Game. The play-stopped-state begins when a Field-Game official blows the whistle to indicate a dead ball. When the game-system is in the Play-stopped-state a wagerer is allowed to select and submit predictions.

Remote terminal: the game apparatus, software or a machine that communicates between the prediction-system-server and the wagerer, allowing the wagerer to send and receive information synchronously or asynchronously.

Submit-prediction-mode: the Submit-prediction-mode is determined, preferably, by the SKWRZ- referee and starts when the ball is dead and ends when the ball is live or snapped. In the submit- prediction-mode, a wagerer in active-mode can submit next play predictions.

Submit-prediction-state: The Submit-prediction-state, preferably determined by the SKWRZ referee, starts when the ball is dead and ends when the ball is live or snapped. In the submit- prediction-state, a wagerer in active-mode can submit a next play prediction. While the invention has been described with reference to a preferred embodiment, those skilled in the art will understand that various changes may be made and equivalents may be substituted without departing from the scope of the invention. In addition, many modifications may be made to adapt a particular step, structure, or material to the teachings of the invention without departing from its scope. Therefore, it is intended that the invention not be limited to the particular embodiment disclosed, but that the invention will include all embodiments falling within the scope of the appended claims.

What is claimed is:

1. A method for predicting an outcome during a live sporting event, the method comprising: sending a pre-game and/or in-game prediction prompt to a user (account holder) from a game system on a prediction-server-system before and/or during a live sporting event; submitting pre-game and/or in-game numerical scoring predictions to a game system on a prediction-server-system as a response to said prediction prompt; determining the game outcome(s) based on a said live game (live sporting event) outcome; and transmitting a game outcome representation to a web page and/or mobile device.

2. The method of claim 1, including transmitting said prediction prompt to a web page and/or mobile device.

3. The method of claim 1, including submitting said pre-game and/or in-game numerical scoring predictions from a web page and/or mobile device in response to said prediction prompt.

4. A method for monetary (cash) wagering on a live sporting event, the method comprising: sending and receiving a pre-game and/or in-game monetary (cash) wager for a sporting event at a game system on a prediction-system-server in conjunction (conjoined) with said pre-game and/or live in-game prediction from an account holder (wagerer); determining an actual game outcome for said live sporting event; transmitting an actual game outcome representation; determining the cash payout (if any) for said pre-game and in-game monetary wager made in conjunction with said pre-game and/or live in-game prediction based on said actual live game outcome.

5. The method of claim 4, including transmitting said pre-game and in-game prediction conjoined with said monetary wager to said game system on said prediction-system-server using a web page and/or mobile device.

6. The method of claim 4, including storing said pre-game and in-game prediction and said conjoined wager on said game system on said prediction-system-server.

7. The method of claim 4, including transmitting said live game (live sporting event) outcome representations (post mortem) to a web page and/or mobile device.

8. The method of claim 4, wherein the wagering system is comprised of an individual cash pool that is established for each said prediction prompt representing a specific event (i.e. one cash pool for Prompt 1 for a Raiders vs Chiefs football game, one cash pool for Prompt 2 for a 49ers vs Seahawks football game, one cash pool for Prompt 3 a Chargers vs Broncos football game etc.) and comprised of the total amount wagered by all account holders as a response to each said prediction prompt (i.e. $100 wagered on Prompt 1, $500 wagered on Prompt 2, $1,000 wagered on Prompt 3 etc.). All live game (sporting event) outcomes that are correctly predicted by an account holder (team/athlete scoring) will pay out a cash award based on each account holder's specific prediction(s) and cash wager(s) in said individual cash pool (i.e. in direct correlation to the total amount that was wagered on said game event).

9. The method of claim 4, wherein a standard gaming fee (i.e. a standard approved entrance fee and/or percentage fee based on local, state and/or federal allowances—TBD per legal states—$1 fee per wager, $5 fee per wager, $10 fee per wager and so on) is deducted from each said cash pool for each individual pre-game and in-game monetary wager that is made before or during a live game (sporting event), prior to the cash award payout of any winnings to an account holder (if any).

10. The method of claim 4, wherein the total of each said cash award (the account holders share of winnings) is determined by the total amount that each account holder wagered and contributed to said cash pool (i.e. if a cash pool totals $1,000 and 1 out of 100 account holders predicted the game outcome correctly, 1 account holder will win the $1,000 cash pool—only after said standard processing fee(s) have been deducted).

11. The method of claim 4, wherein submitting a minimum volume (frequency) of required in-game predictions and monetary wagers during a live sporting event (i.e. a three-wager minimum) qualifies the wagerer to play in subsequent “bonus rounds” (i.e. to be able to play in the fourth quarter and/or overtime (if any) or a separate bonus game).

12. The method of claim 4, wherein said bonus rounds may payout additional prizes and/or larger cash returns for correct predictions during said bonus rounds during a live game (live sporting event).

13. The method of claim 4, wherein transmitting a pre-game and/or in-game prediction and monetary wager comprises transmitting over a network via a web page and/or mobile device.

14. A live game system and prediction-system-server comprising: a live game server adapted to send a pre-game and/or in-game prediction prompt to a user (account holder) over a communication interface located on a web page and/or mobile device adapted to receive said pre-game and/or in-game prediction prompt; a live game server adapted to receive pre-game and in-game predictions conjoined with monetary wagers from account holders (wagerers) over a communication interface located on a web page and/or mobile device adapted to submit said pre-game and in-game predictions and monetary wagers to said prediction-system-server, the web page and/or mobile device responsive to a live game outcome representation (post mortem) to update an account holder's (wagerer's) cash account (+/−) based on the actual game outcome and said pre-game and in-game predictions and monetary wagers.

15. The live game system of claim 14, wherein said pre-game and in-game prediction prompts and said predictions are based on a specific statistical and/or scoring category and time frame within the live game (i.e. points scored by a specific team during the first quarter, first half, first three periods or the entire game of a live sporting event).

16. The live game system of claim 14, further comprising tabulating and storing an account holder's (wagerer's) winnings (if any) in a system memory and displaying their deposits, winnings (if any), the standard fee deductions and withdrawals (losses) in their account (i.e. the balance activity reflected as +/−, similar to a bank statement)

17. The live game system of claim 14, wherein said account holders (wagerers) can create private or public Groups that will allow the Group members (a Group creator and his or her invitees) to predict and wager within a specifically selected game (or games) over a shared communication interface before or during a live game (live sporting event).

18. The live game system of claim 14, wherein a said account holder (wagerer) that has created a private or public Group and choose from a variety pre-established limited “betting rules” for said private or public Group (i.e. require a specific wagering amount (a flat amount as a minimum or a maximum) per each prediction and/or specify a single category of prompts for each individual wager in a Group for any given game (i.e. limit wagers to specific prediction sub-categories like “full game score only” or “First Half and Final scores only” or “scrambled score numbers only”.

19. The live game system of claim 14, wherein said account holders (wagerers) that have created and/or joined said private or public Group will equally share within the entire group the total cash winnings paid out of each said cash pool (if any) for each said prediction and wager that is made during the live game (live sporting event) by said Group.

20. The live game system of claim 14, wherein said live game system and live game-system server(s) can include, or be limited to, a single casino network environment, multiple casino network environments or a regional and/or global casino network environment.

21. A prediction measuring system functionality (“action gauge”) that displays all system wide prediction activity (all wagering action) with each prediction prompt that is broadcast to any participating account holders in the system, displaying a thin horizontal color bar with each block of color representing the percentage of predictions that have been submitted for each game that is offered (i.e. 15% selected game A—in blue, 20% selected game B—in black, 65% selected game C—in white), providing a decision tool for the account holders (wagerers) before they make their selections.

22. A GPS system functionality comprising: programming to specifically identify and locate each PC and/or smart phone device of an account holder (wagerer) that is operating the SKWRZ system, based on their geographic location as it pertains to their relationship to the state lines of an approved regulated state, province or territory, individual country and/or physical property lines of a regulated casino property (i.e. a single Las Vegas property or an Indian Casino located in a sovereign land territory or on other lands that are approved for Indian Gaming).

23. The GPS system functionality of claim 22, wherein the said programming provides automated start-stop functionality to control the legal and illegal use and operability as it pertains to said state lines of a regulated state, province or territory, individual country and/or physical property lines of a regulated casino property (i.e. a single Las Vegas property or an Indian Casino located in a sovereign land territory or on other lands that are approved for Indian Gaming).

24. An online social network system comprising: accessibility via a web page and/or mobile device, tables displaying and ranking single account holders (wagerers) and/or Groups comprised of numerous account holders (wagerers) by user name (or other unique identifiers), the daily outcomes of all individual and combined sporting events and the corresponding correct predictions tabulated by said prediction-system-server, tables displaying the combined daily monetary wagers and cash payouts tabulated by said prediction-system-server; open “friending” toolset functionality that provides invitations to share game history and other personal information between players while restricting access to “non-friends”, the posting of account holder photos, messaging and microblogging, and custom page creation and functionality for each account holder (wagerer).

25. The online social network system of claim 24, wherein said game system and prediction-system-server automatically rewards more active and/or higher ranking account holders (wagerers) with casino rewards points that are redeemable for bonus cash and/or various casino goods and services (TBD by each individual casino system). The awarding of said rewards points will be based on a customizable and adaptable system comprised of varying rule sets for frequent casino visitation, high wagering activity, and average wager amount, among other rule sets.

26. The online social network system of claim 24, wherein said game system and prediction-system-server automatically assigns a “skill level” to each account holder (wagerer) as it pertains to their overall frequency of play, winning percentage and corresponding skill level. Said skill level titles may consist of four or more skill levels: 1—Rookie (R), for new account holders and/or account holders with lower levels of activity and/or lower winning percentages (i.e. 0-25%), 2—Veteran (V), for more active and experienced account holders and/or account holders with higher winning percentages (i.e. 26%-50%), 3—All-Pro (AP), for account holders with consistently high winning percentages (i.e. 51-75%), and 4—Hall of Fame (HOF), for account holders maintaining very high winning percentages (i.e. 76+%).

27. The online social network system of claim 24, wherein said game system and prediction-system-server automatically assigns “single game” skill level titles to each account holder (wagerer) based on their single game performance within the social network, a particular Group or their own historical performance(s). A—MVP, B—Game High (GH), E—Personal Best (PB)
